(19) United States
(12) Patent Application Publication
(10) Pub. No.: US 2026/0259876 A1
(43) Pub. Date: Sep. 3, 2026

(54) ENHANCING SEARCH QUERY ASSESSMENTS VIA A SEARCH QUERY SIMILARITY INDEX

(71) Applicant: RELX Inc., Miamisburg, OH (US)

(72) Inventors: Vaqar Khamisani, Sandhurst (GB); Robert Evan Miracle, Raleigh, NC (US); Soha Khazaeli, Cary, NC (US)

(21) Appl. No.: 19/067,169

(22) Filed: Feb. 28, 2025

(51) Int. Cl. G06F 16/2453

(52) U.S. Cl. CPC G06F 16/24537

(57) ABSTRACT

Systems, methods, and computer-readable media for search query improvement. A method includes receiving, by a processing device, a set of search queries; generating, by the processing device, a cluster similarity score for the set of search queries based on a similarity index, wherein the similarity index is configured to consider each search term of one or more search queries of the set of search queries; determining, by the processing device, based on the similarity score, a success outcome of the set of search queries; and displaying, on a display device, at least one of the similarity score, the success outcome, or other scores or metrics associated with the set of search queries.

### BACKGROUND

### Field

The present specification generally relates to utilizing a similarity index to better assess and improve search queries in an online environment such as a search platform.

### Technical Background

Search queries are user input queries in a search engine or other electronic search platform to find information. A search query can consist of terms made up of keywords, phrases, or questions that help the online platform retrieve or suggest relevant results. A search query may be input via text audio, or other audio-visual inputs. A search query's effectiveness may be measured by the relevant search results it causes to be produced as well as user satisfaction with these results.

### SUMMARY

In one embodiment, a method for search query improvement, that includes receiving, by a processing device, a set of search queries, generating, by the processing device, a cluster similarity score for the set of search queries based on a similarity index, wherein the similarity index is configured to consider each search term of one or more search queries of the set of search queries, determining, by the processing device, based on the similarity score, a success outcome of the set of search queries; and displaying, on a display device, at least one of the similarity score, the success outcome, or other scores or metrics associated with the set of search queries.

In another embodiment, a system for advanced search queries, that includes a processing system with one or more processors and one or more memories coupled with the one or more processors, the processing system configured to cause the system to receive, by a processing device, a set of search queries, generate, by the processing device, a cluster similarity score for the set of search queries based on a similarity index, wherein the similarity index is configured to consider each search term of one or more search queries of the set of search queries, determine, by the processing device, based on the similarity score, a success outcome of the set of search queries, and display, on a display device, at least one of the similarity score, the success outcome, or other scores or metrics associated with the set of search queries.

In yet another embodiment, one or more non-transitory computer-readable media include executable instructions that, when executed by one or more processors, perform operations comprising receiving, by a processing device, a set of search queries, generating, by the processing device, a cluster similarity score for the set of search queries based on a similarity index, wherein the similarity index is configured to consider each search term of one or more search queries of the set of search queries, determining, by the processing device, based on the similarity score, a success outcome of the set of search queries, and displaying, on a display device, at least one of the similarity score, the success outcome, or other scores or metrics associated with the set of search queries.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for enhancing search query assessments with a similarity index according to one or more embodiments shown and described herein;

FIG. 2 schematically depicts the server computing device from FIG. 1, further illustrating hardware and software that may be used in enhancing search query assessments with a similarity index using a software program in real time according to one or more embodiments shown and described herein;

FIG. 3 depicts an example of various components of a set of search queries, according to one or more embodiments shown and described herein; and

FIG. 4 depicts a flow diagram of a method of enhancing search query assessments with a similarity index according to one or more embodiments shown and described herein.

### DETAILED DESCRIPTION

As digital searching technologies advance and leverage techniques such as machine learning (ML), artificial intelligence (AI), as well as more complex search algorithms, they not only generate improved search results but also display or provide the results to the requesting user in more user-friendly and accessible formats, a need therefore exists to also advance the assessment and evaluation of search queries and their results to further improve search platforms.

A search query may be defined as a specific set of words or phrases that are input (e.g., by a user) into a search platform. A search platform may include various information searching and retrieval systems and technologies including search engines, large language models (LLM), other ML or AI models, commercial and marketplace search platforms, e.g., e-commerce platforms, or job search sites, as well as knowledge management software, e.g., specialized/technical knowledge domain platforms such as online scientific publication platforms. The input to a search platform may be referred to as a search query. The search query may be made up of keywords, questions, or natural language expressions that convey what the user wants to find. The search query can also take various forms such as text, audio, images, as well as other data files and formats. The search platform interprets this query to deliver relevant results from its indexed database. The clarity and specificity of a search query often influences its effectiveness.

The search platform produces a search result in response to the search query. A search result may be defined as any output generated by the search platform in response to a user's search query. In certain instances, the search result includes items of a list of items, such as web pages, documents, images, or videos that are deemed relevant to the user's search terms. Each search result may contain a title, a brief description, snippet of the content, or a link to access the full material. The order of results may be determined by algorithms that assess relevance, authority, and other factors to provide the most useful information first.

Assessing a search query can involve several factors including its relevance (alignment with user intent), accuracy of the search results produced, the newness of the search results, e.g., freshness of news items, credibility of the sources, the user's engagement with the result(s), the diversity of results, and types of the results, and the local relevance of the results (e.g., geographical proximity to an IP address). However as user interfaces (UI) for search engines or other search platforms improve, the information sought by the user performing the search (referred to herein as a user), may be displayed to the user without any interaction with the source page or document containing the information. For example an AI model, such as a large language model (LLM) used by the search platform may collate information that was crawled, e.g., by the search engine, summarize it, and then present it to the user in an easily digestible format on a result page UI without the user having to interact, e.g., click on, the search result itself.

Such instances, where a user may obtain the search result information without interacting with a search result (e.g., the source page or document) directly makes it difficult to assess the search query. This is because user engagement with search results, e.g., by clicking or interacting with the result, is an important factor used to assess the effectiveness of the search query. However, due to advancements in both search platforms, the way they display search results, and their associated information to users, in certain instances, effective interactions with a search platform produce search results that cause the user to engage in “good abandonment,” which is when the user finds or is presented with search results to the search query with no need to interact with search results directly, allowing the user to move on to another search.

Due to the improvement in search platforms and search techniques and the displaying of search results that may result in good abandonment, a need exists for systems and methods that assess the effectiveness of a search query while taking into account good abandonment. Accordingly, referring generally to the figures, embodiments described herein are directed to systems, methods, and computer-readable media for improving measuring the effectiveness of search queries. The systems, methods, and computer-readable media described herein measure the effectiveness of a search query or a set of search queries based on a similarity index. The similarity index is a benchmark or metric algorithm to quantify how similar two or more entities are to each other, e.g., a similarity of search terms within a set. The similarity takes into consideration all terms in the search query or the set of search queries. The similarity index herein can generate a similarity score that is then used to determine whether the set of search queries was successful and recognizes or considers occurrences of good abandonment.

The present disclosure is intrinsically related to band performed within the field of search platforms and information retrieval systems. Methods and systems are disclosed herein to perform enhanced search query effectiveness assessments that can be applied to search results where good abandonment may occur. One technical benefit of the present disclosure is to improve search query effectiveness assessments (query assessment) of search platforms, resulting in better search query understanding and improved learning outcomes by the search platforms. Analyzing search query effectiveness helps improve natural language processing (NLP) models. For instance, a virtual assistant could become better at understanding user queries and provide more accurate responses.

The present disclosure, through enhanced assessment of search queries, also provides the technical benefit of improved categorization of search result data and their associated search queries and labeling of this data. Improved categorization and any consequent labeling of data allows use of this data to train ML algorithms and models to generate improved search queries, improve algorithm performance, and improve search result outcomes. By refining search queries and search query algorithms based on query assessments, search engines can deliver more precise results. For instance, a retail site could improve its product recommendations by analyzing which search queries lead to sales. Better query assessments therefore can lead to feedback loop integration that establishes feedback loops to facilitate continuous improvements to search algorithms based on better query assessments.

Various other technical benefits are associated with improving the assessment of search queries. One benefit is reducing latency with optimized search processes that rely on improved query assessments, which leads to quicker response times. Improved latency may for instance cause a search platform such as a streaming service to enhance its search speed, allowing users to find shows and movies faster, even during peak times. Other improvements and technical benefits to search platforms may include improved ranking mechanisms and ranking algorithms based on the effectiveness of the search results produced by the search query.

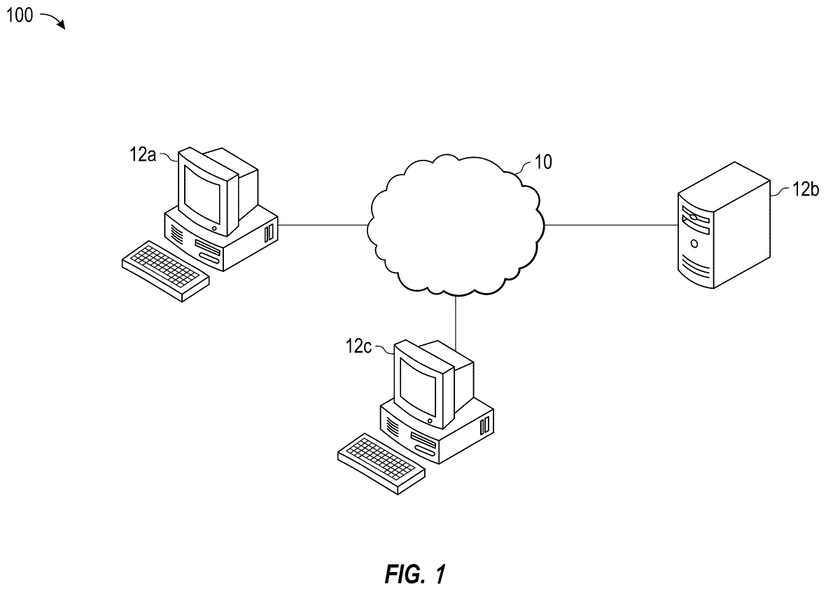

Referring now to the drawings, FIG. 1 depicts an illustrative computing network that depicts components for a system for enhancing search query assessments according to embodiments shown and described herein. As illustrated in FIG. 1, a computer network 10 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 10 may generally be configured to electronically connect one or more computing devices and/or components thereof. Illustrative computing devices may include, but are not limited to, a user computing device 12a, a server computing device 12b, and an administrator computing device 12c.

The user computing device 12a may generally be used as an interface between a user and the other components connected to the computer network 10. Thus, the user computing device 12a may be used to perform one or more user-facing functions, such as receiving one or more inputs from a user or providing information to the user, as described in greater detail herein. Accordingly, the user computing device 12a may include at least a display and/or input hardware, as described in greater detail herein. In some embodiments, the user computing device 12a may contain the software that is evaluated, as described herein. Additionally, included in FIG. 1 is the administrator computing device 12c. In the event that the server computing device 12b requires oversight, updating, or correction, the administrator computing device 12c may be configured to provide the desired oversight, updating, and/or correction. The administrator computing device 12c may also be used to input additional data into a corpus of data stored on the server computing device 12b.

The server computing device 12b may receive data from one or more sources, generate data, store data, index data, search data, and/or provide data to the user computing device 12a in the form of a software program, questionnaires, and/or the like.

It should be understood that while the user computing device 12a and the administrator computing device 12c are depicted as personal computers and the server computing device 12b is depicted as a server, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, components, and/or the like.

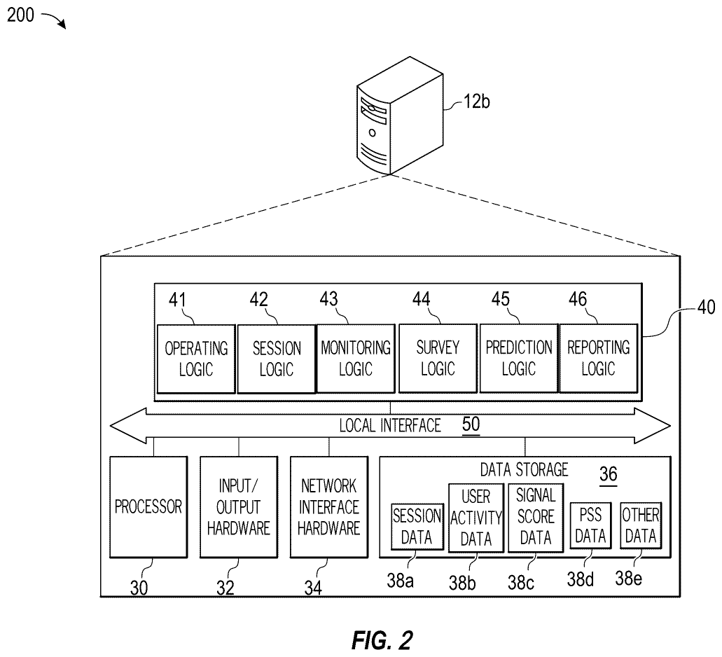

FIG. 2 depicts the server computing device 12b, from FIG. 1, further illustrating a system for enhancing search query assessments. While the components depicted in FIG. 2 are described with respect to the server computing device 12b, it should be understood that similar components may also be used for the user computing device 12a and/or the administrator computing device 12c (FIG. 1) without departing from the scope of the present disclosure.

The server computing device 12b may include a non-transitory computer-readable medium for searching and providing data embodied as hardware, software, and/or firmware, according to embodiments shown and described herein. While in some embodiments the server computing device 12b may be configured as a general-purpose computer with the requisite hardware, software, and/or firmware, in other embodiments, the server computing device 12b may also be configured as a special purpose computer designed specifically for performing the functionality described herein. In embodiments where the server computing device 12b is a general-purpose computer, the methods described herein generally provide a means of improving a matter that resides wholly within the realm of computers and the internet (i.e., improving the functionality of software).

As also illustrated in FIG. 2, the server computing device 12b may include a processor 30, input/output hardware 32, network interface hardware 34, a data storage component 36 (which may store session data 38a, user activity data 38b, signal score data 38c, Product Success Score (PSS) data 38d, and other data 38e), and a non-transitory memory component 40. The memory component 40 may be configured as a volatile and/or a nonvolatile computer-readable medium and, as such, may include random access memory (including SRAM, DRAM, and/or other types of random access memory), flash memory, registers, compact discs (CD), digital versatile discs (DVD), and/or other types of storage components. Additionally, the memory component 40 may be configured to store various processing logic, such as, for example, operating logic 41, session logic 42, monitoring logic 43, survey logic 44, prediction logic 45, and/or reporting logic 46 (each of which may be embodied as a computer program, firmware, or hardware, as an example). A local interface 50 is also included in FIG. 2 and may be implemented as a bus or other interface to facilitate communication among the components of the server computing device 12b.

The processor 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data (e.g., a device that allows for direct or indirect user interaction with the server computing device 12b). The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data and selectively provide access to the one or more pieces of data. As illustrated in FIG. 2, the data storage component 36 may store session data 38a, user activity data 38b, signal score data 38c, PSS data 38d, and/or other data 38e, as described in greater detail herein.

Included in the memory component 40 are the operating logic 41, the session logic 42, the monitoring logic 43, the survey logic 44, the prediction logic 45, and/or the reporting logic 46. The operating logic 41 may include an operating system and/or other software for managing components of the server computing device 12b. The session logic 42 may provide a software product to the user in the form of an interaction session, such as a research session or the like, as described in greater detail herein. The monitoring logic 43 may monitor a user's interaction with a software product during an interaction session and determine one or more metrics from the user's interaction that are used for performance determination and/or prediction, as described in greater detail herein. The survey logic 44 may provide a post-software experience survey to a user after the user has interacted with a software program. The prediction logic 45 may predict a user's response to software based on historical data. The reporting logic 46 may provide data to one or more users, where the data relates to the evaluation of the interaction between the user and the software program.

It should be understood that the components illustrated in FIG. 2 are merely illustrative and are not intended to limit the scope of this disclosure. More specifically, while the components in FIG. 2 are illustrated as residing within the server computing device 12b, this is a nonlimiting example. In some embodiments, one or more of the components may reside external to the server computing device 12b. Similarly, as previously described herein, while FIG. 2 is directed to the server computing device 12b, other components such as the user computing device 12a and the administrator computing device 12c may include similar hardware, software, and/or firmware.

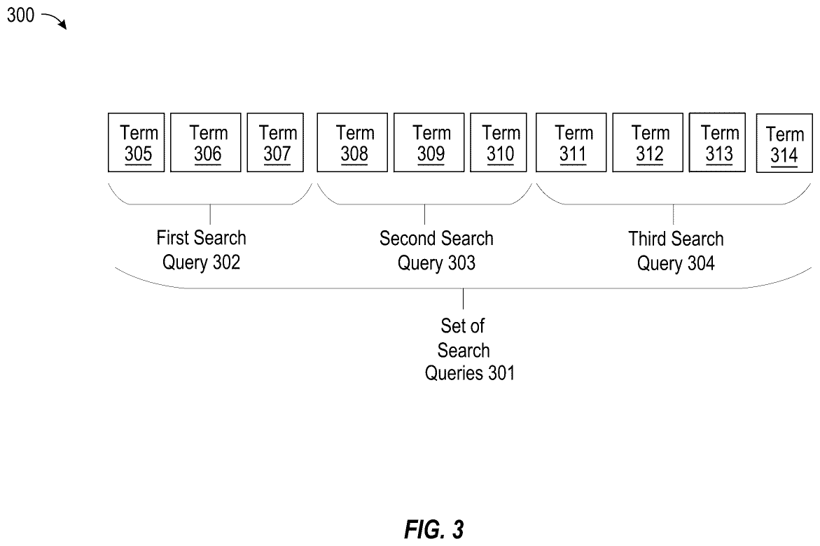

FIG. 3 depicts an example 300 of the various components of a set of search queries 301(also referred to herein as set 301). In the example 300, the set 301 can include a first search query 302, a second search query 303 and a third search query 304. Each search query 302-304 may include one or more search terms. For example, the first search query 302 may include terms 305-307, while the second search query 303 may include search terms 308-310, and the third search query 304 may include terms 311-314. Therefore, the set 301 includes the search terms 305-314. Each search query 301-303 may generate one or more sets of search results.

In some embodiments, a set 301 is defined by the number of search queries. For example the set 301 may be limited to a minimum or maximum number of search queries. The set 301 may also be defined by a duration, where the search queries 302-304 of the set 301 occur within this duration. A duration may be defined by an administrator, a user submitting a query (user), or be a system-defined limit, e.g., based on system configurations or settings. The set 301 may also directly correspond to or fall within a search query session. For example, search queries that occur within a search query session become part of the set 301, meanwhile any search queries occurring outside of the search session fall outside of the set 301.

In some embodiments, a search query session may be initiated or ended by a user via one or more user inputs or commands, or may be initiated or ended by a timer that defines its start or end points. In some embodiments, a search query session may end based on a pause in user inputs or interaction, e.g., interactions with a search platform. For example, after a search session commences and a user inputs one or more search queries, a pause may be detected by the search platform during which the user is not interacting with the search platform, e.g., is not submitting search queries. Based on preset, AI-based, or administrator manually-defined configurations, the pause may have a maximum threshold limit, which if met or exceeded, the search session is automatically terminated. The search queries that occur within the session prior to its termination then fall within the set 301.

The set 301 may also be defined by a number of search queries or a number of search terms. For example, a search platform may set a maximum number of search queries that can fall within the set 301. Any search query above the maximum limit would then be assigned into a different set of search queries.

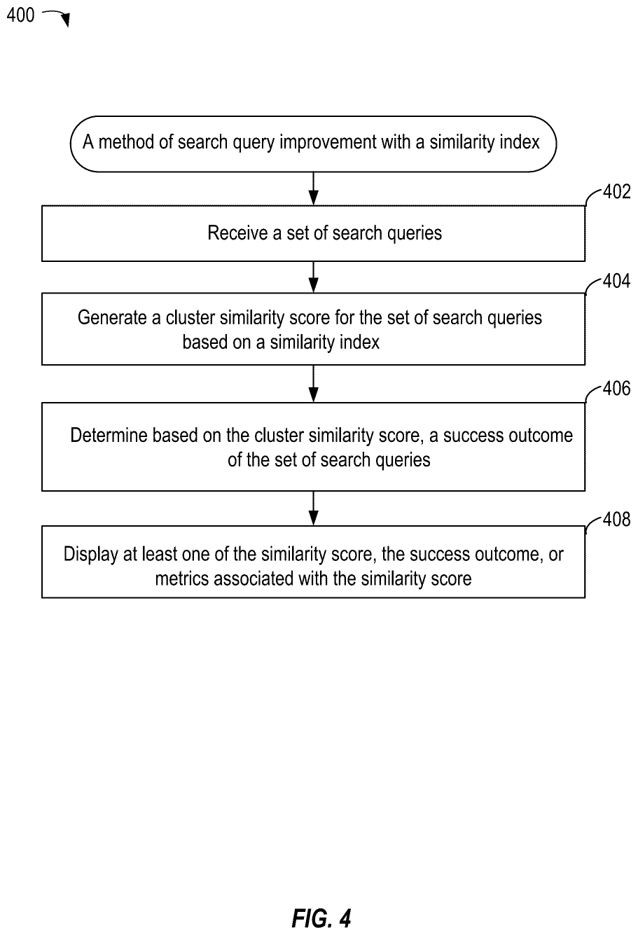

As mentioned above, the various components described with respect to FIG. 2 may be used to carry out one or more processes and/or provide functionality for enhancing search query assessments with a similarity index. An illustrative example 400 of the various processes is described with respect to FIG. 4.

Example 400 commences at 402, where a system, such as a search platform, e.g., running on a server computing device 12b of FIG. 1, receives a set of search queries (set), e.g., the set 301 of FIG. 3. The receiving of the set may occur in real-time, or it may occur upon the end or completion of the set. For example, it may occur in real-time during user inputs of a search query or at the end of a search query session or end of the duration during which search queries were being input by a user. The finalized set may be sent to and received by the search platform, or server computing device running it. The set may be received in a complete form. In some embodiments, the receipt at 402 of a set may occur incrementally, for example, search query by search query (e.g., in real-time) until the full set is received.

At 404, the system generates a cluster similarity score for the set of search queries, e.g., to determine how similar the search queries or terms in the set are to each other. The cluster similarity score is generated based on a similarity index algorithm (similarity index). The similarity index is configured to consider every search term, e.g., search terms 305-314 of FIG. 3 in the set of search queries. The cluster similarity score represents the similarity of search terms in the set of search queries. The more similar the search terms in the set, the higher the cluster similarity score. A higher cluster similarity score therefore represents a higher number of similar terms or search queries in the set, and indicates less effective search queries, indicating that similar search queries had to be repeated and refined. A lower cluster similarity score represents more diverse search terms and therefore more effective search queries, since it indicates that the user moved on to different searches, e.g., relating to different topics, using dissimilar terms, and may even indicate good abandonment where a user moves on to the next search without interacting with search results of a search query.

In some embodiments, the generating of the cluster similarity score at 404 may include determining, by the system, a similarity score for each search query (search query similarity score), e.g., search queries 302-304 of FIG. 3. Unlike a cluster similarity score that is generated considering all search terms in the set of search queries against all other search terms in the set to generate a score for the set, the search query similarity score is generated based on search terms in one search query in relation to search terms in one or more other search queries in the set, e.g., in relation to each term of second search query 303 or each term of third search query 304 of FIG. 3 (or both), and this can be determined based on the similarity index for each search query individually, where the similarity index is configured to consider each search term in the search query in relation to each search term of each other search query under consideration. For example, if the first search query similarity score is to be determined, then a search query similarity score may be generated by first comparing the first search query 302 of FIG. 3 against the second search query 303, and then comparing the first search query 302 against the third search query 304. Each of these comparisons individually may be used as a similarity score for the first search query 302, or as an example, a mean score may be generated of the two generated scores to derive the similarity score for the first search query 302. Numerous other mathematical and statistical techniques may be applied to the scores to derive the similarity score for each search query.

Therefore, while a cluster similarity score of the set is determined based on all the terms in the set, the similarity of a search query may be determined based on the terms in the search query and one or more other search queries in the set. In some embodiments, the generating of the cluster similarity score at 404 can also include aggregating the various generated search query similarity scores, e.g., the set 301 of FIG. 3. For example, a similarity score is calculated for each of the search queries in the set individually, e.g., search queries 302-304 of FIG. 3, as described above, and then the various search query similarity scores can be aggregated to obtain the cluster similarity score. In some embodiments, a mean similarity score of all the search query similarity score(s) may be generated, or other statistical techniques may be applied to determine the cluster similarity score. The cluster similarity score and the search query similarity score(s) may be referred to herein collectively and interchangeably, where appropriate, simply as similarity score(s).

Generating the similarity score(s) based on the similarity index, e.g., at 404 can include determining an entropy for the set, or determining a similarity metric value for the set. In some embodiments, the entropy may be determined based on the system computing the entropy with the following equation:

$$entropy = {\sum }_{i = 1}^{n} {w}_{i} {log}_{2} ( {w}_{i} ) = {w}_{1} {log}_{2} ( {w}_{1} ) + {w}_{2} {log}_{2} ( {w}_{2} ) + … + {w}_{n} {log}_{n} ( {w}_{n} )$$

In some embodiments, w₁ represents a first number of occurrences of a first unique search term, e.g., search term 307 of FIG. 3, in the set of search queries, and w₂ represents a second number of occurrences of a second unique search term in the set, e.g., search term 309 of FIG. 3, and wₙ represents another number of occurrences of another unique search term in the set e.g., search terms 310 or 311 of FIG. 3. Unlike the entropy for the set which includes all terms in the set, the entropy for a search query is limited to search terms of the search queries involved in generating the search query similarity score as described above. In some embodiments, w is the frequency of the number of occurrences of a unique search term in the set of search queries over the total number of search terms in the set of search queries.

In some embodiments, determining the similarity score for the set or for a search query may comprise determining the similarity metric value which can include determining a ratio of a total number of search terms in the set over a total number of unique search terms in the set of search queries. For example, the similarity metric value may be determined according to the following equation:

$$Similarity metric value = total search terms / total number of unique search terms$$

Unlike the similarity metric value for the set which includes all terms in the set, the similarity metric value for a search query is limited to search terms of search queries involved in generating the search query similarity score as described above.

At 406, the example 400 may include determining a success outcome of the set e.g., the set 301 of FIG. 3, based on the similarity score(s) generated at 404. In some embodiments, this may include classifying the success outcome of the set or of individual search queries of the set. For example, this determination at 406 may be based on a search query similarity score, or a cluster similarity score for the set. The success outcome of the set may be determined based on the cluster similarity score, while the success outcome of a search query may be determined based on the similarity score of a search query. For example, to determine the success of a single search query, a search query is compared with the next search query and the similarity between both of them is computed. If they are very similar than the former search query was not successful. If there is no similarity than the former search term was successful.

The determining of the success outcome may include classifying the similarity score(s) as successful or unsuccessful based on whether the similarity score(s) meet of fall below a predefined threshold. The threshold may be set by the system or set manually by an administrator. The success outcome may be determined for one or more search queries, e.g., based on the search query similarity score, or for the set, based on the cluster similarity score.

The generating of the cluster similarity score at 404 and the determining of the success outcome based on that similarity score at 404 provides the technical benefit of improved categorization of search result data and their associated search queries and labeling of this data. Improved categorization and any consequent labeling of data allows use of this data to train ML algorithms and models to generate improved search queries, improve algorithm performance, and improve search result outcomes. By refining search queries and search query algorithms based on query assessments, search engines can deliver more precise results. The success outcome and cluster similarity score of the set also improve search query assessments of search platforms, resulting in better search query understanding and improved learning outcomes by the search platforms.

In some embodiments, at 408, the example 400 includes displaying performance metrics, which may include displaying at least one of the cluster similarity scores, the success outcome, or other scores or metrics associated with the set of search queries e.g., the search query similarity scores. In some embodiments, the performance metrics are used as inputs into the search platform or a database.

In some embodiments, the example 400 includes commencing, by the processing device, a duration to perform one or more search queries and ending the duration, wherein the set of search queries comprises the one or more search queries. The duration may be a predefined time period that may be set by the system, the user, or an administrator, where all search queries within the duration may comprise one set of search queries. In some embodiments, the duration that defines the set may be defined by the user inputting a starting point of the duration or an ending point of the duration.

The set may also have a size limit, which may include a range of an acceptable number of search queries or search terms, e.g., the search queries 302-304, and the search terms 305-314 of FIG. 3. The size may be set by the system, the user, or an administrator. The system may receive an indication that configures the size limit, for example a user input or a configuration file.

In some embodiments, the set of search queries may be defined as those search queries that occur within a search query session. A search query session may be initiated by the system, for example in response to a user input or user search query, and then the search query may be ended by a user or by the system. The search session may also include one or more pauses, where a pause may be associated with a user not inputting additional or new search queries. The system may set a maximum time limit for pauses, which if met or exceeded may end the search session automatically.

In some embodiments, the example 400 can include adding the set or the one or more search queries to a data repository. The data repository may correspond to, as an example, the data storage 36 of FIG. 2. The data stored in the data repository may be referred to herein as search data. For example, a set or search queries that meet a certain success outcome, e.g., a classification of being ‘successful’, or a specific similarity score, e.g., one that is below a predefined maximum or threshold may be added to the data repository. This search data may be preprocessed and stored as labeled data that can be used to train ML models associated with the system. The search data may also be stored in association with search result data.

In some embodiments, the search data in the data repository may be retrieved in real-time, at a later time, or be triggered by an event, e.g., a user query, to be used by the system, for example, to provide search query recommendations, e.g., to the user, based on a currently active or ongoing search query or search session containing a set of search queries. Furthermore, the retrieved set of search queries may be used to train the system or its search models, or it may be used to enhance the precision of search results provided to the user by the system. In some embodiments, the data retrieved from the repository may be used by the system to automatically replace one or more search terms of a user's search query to improve the active search query.

In some embodiments, the retrieval of the search data may be triggered by a specific similarity score, or success outcome. For example, a similarity score may be generated for a current set of search queries during an active and on-going search query during a search session, e.g., a high similarity score that indicates a success search outcome of unsuccessful search queries. In this example, the system may retrieve previously stored search data to either provide search query recommendations to the user for the next search query or automatically replace user inputs to refine a user search query based on the retrieved search data and to improve the success outcome.

### Example Clauses

Implementation examples are described in the following numbered clauses:

Clause 1: A method for search query improvement, comprising: receiving, by a processing device, a set of search queries; generating, by the processing device, a cluster similarity score for the set of search queries based on a similarity index, wherein the similarity index is configured to consider each search term of one or more search queries of the set of search queries; and determining, by the processing device, based on the similarity score, a success outcome of the set of search queries.

Clause 2: The method of Clause 1, further comprising: displaying, on a display device, at least one of the cluster similarity score, the success outcome, or other scores or metrics associated with the set of search queries.

Clause 3: The method of any of Clauses 1-2, wherein the generating of the cluster similarity score for the set of search queries comprises: determining, by the processing device, a search query similarity score for each search query of the set of search queries, wherein the search query similarity score for the search query is determined based on a similarity of each search term in the search query to each search term of each other search query of the set of search queries.

Clause 4: The method of any of Clauses 1-3, wherein the generating of the cluster similarity score for the set of search queries further comprises: aggregating, by the processing device, the search query similarity score of each search query of the set of search queries to generate the cluster similarity score.

Clause 5: The method of any of Clauses 1-4 wherein the method further comprises: determining, by the processing device, a search query success outcome of a search query of the set of search queries based on the search query similarity score of the search query; and classifying by the processing device, the search query success outcome as a successful search query based on the search query similarity score falling below a predefined threshold.

Clause 6: The method of any of Clauses 1-5 wherein the determining of the success outcome further comprises: classifying by the processing device, the success outcome as successful based on the cluster similarity score falling below a predefined threshold.

Clause 7: The method of any of Clauses 1-6 wherein the similarity index comprises determining an entropy for the set of search queries.

Clause 8: The method of any of Clauses 1-7 the determining of the entropy comprises computing: entropy=w₁ log₂(1/w₁)+w₂ log₂ (1/w₂)+wₙ logₙ(₁/logₙ), wherein w₁ represents a first number of occurrences of a first unique search term in the set of search queries, and wherein w₂ represents a second number of occurrences of a second unique search term in the set of search queries, and wherein wₙ represents another number of occurrences of another unique search term in the set of search queries.

Clause 9: The method of any of Clauses 1-8, wherein the similarity index comprises determining a similarity metric value for the set of search queries.

Clause 10: The method of any of Clauses 1-9, wherein the determining of the similarity metric value comprises determining a ratio of total search terms over total unique search terms in the set of search queries.

Clause 11: The method of any of Clauses 1-10, further comprising: commencing, by the processing device, a duration to perform one or more search queries; and ending the duration, wherein the set of search queries comprises the one or more search queries.

Clause 12: The method of any of Clauses 1-11, further comprising: receiving one or more user inputs comprising at least one of a user input to set a starting point of a duration or a user input to set an ending point of the duration, wherein the set of search queries comprises one or more search queries performed during the duration.

Clause 13: The method of any of Clauses 1-12, further comprising: receiving an indication configuring a size for the set of search queries, wherein the indication may set a minimum number or a maximum number of search queries for the set of search queries.

Clause 14: The method of any of Clauses 1-13, further comprising: initiating a search query session; and ending the search query session, wherein the set of search queries is performed within the search query session.

Clause 15: The method of any of Clauses 1-14, further comprising: detecting a pause of search queries during the search query session, wherein a pause duration of the pause meets a pause duration limit, and wherein the ending of the search query session is associated with the pause duration meeting the pause duration limit.

Clause 16: The method of any of Clauses 1-15, wherein the receiving of the set of search queries comprises receiving one or more search queries during a search query session.

Clause 17: The method of any of Clauses 1-16, wherein the determining of the success outcome comprises: classifying at least one of a search query of the set of search queries or the set of search queries as successful or unsuccessful based on at least one of the similarity score or a search query similarity score.

Clause 18: The method of any of Clauses 1-17, further comprising: adding, by the processing device, to a data repository, at least one of the set of search queries or a search query of the set of search queries based on the similarity score, the success outcome, or a search query success outcome.

Clause 19: The method of any of Clauses 1-18, further comprising: retrieving, by the processing device, from the data repository, at least one of the set of search queries or the search query based on an active search query or an active set of search queries; and providing a search query recommendation based on the active search query or the active set of search queries, and at least one of the set of search queries or the search query.

Clause 20: The method of any of Clauses 1-19, further comprising: replacing an active search query with a successful search query of the set of search queries based on a similarity score of the active set of search queries or a similarity score of the active search query.

Clause 21: One or more apparatuses, comprising: one or more memories comprising executable instructions; and one or more processors configured to execute the executable instructions and cause the one or more apparatuses to perform a method in accordance with any one of Clauses 1-20.

Clause 22: One or more apparatuses configured for wireless communications, comprising: one or more memories; and one or more processors, coupled to the one or more memories, configured to cause the one or more apparatuses to perform a method in accordance with any one of Clauses 1-20.

Clause 23: One or more apparatuses configured for wireless communications, comprising: one or more memories; and one or more processors, coupled to the one or more memories, configured to perform a method in accordance with any one of Clauses 1-20.

Clause 24: One or more apparatuses, comprising means for performing a method in accordance with any one of Clauses 1-20.

Clause 25: One or more non-transitory computer-readable media comprising executable instructions that, when executed by one or more processors of one or more apparatuses, cause the one or more apparatuses to perform a method in accordance with any one of Clauses 1-20.

Clause 26: One or more computer program products embodied on one or more computer-readable storage media comprising code for performing a method in accordance with any one of Clauses 1-20.

Clause 27: One or more apparatuses configured for wireless communications, comprising: a processing system that includes one or more processors and one or more memories coupled with the one or more processors, the processing system configured to cause the one or more apparatuses to perform a method in accordance with any one of Clauses 1-20.

### Additional Considerations

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

While particular embodiments have been illustrated and described herein, it should be understood that various other changes and modifications may be made without departing from the spirit and scope of the claimed subject matter. Moreover, although various embodiments of the claimed subject matter have been described herein, such embodiments need not be utilized in combination. It is therefore intended that the appended claims cover all such changes and modifications that are within the scope of the claimed subject matter.

1. A method for search query improvement, comprising:
receiving, by a processing device, user inputs comprising a set of search queries;
generating, by the processing device, a cluster similarity score for the set of search queries based on a similarity index, wherein the similarity index is configured to consider each search term of one or more search queries of the set of search queries;
determining, by the processing device, based on the cluster similarity score, a success outcome of the set of search queries, wherein the determining of the success outcome is independent of user interactions;
retrieving search data from a database, wherein the search data is based on the cluster similarity score, the success outcome, or other scores or metrics associated with the set of search queries; and
automatically replacing at least one search term of at least one search query of the one or more search queries based on the search data to generate at least one improved search result.

2. The method of claim 1, wherein the generating of the cluster similarity score for the set of search queries comprises:
determining, by the processing device, a search query similarity score for each search query of the set of search queries, wherein the search query similarity score for the search query is determined based on a similarity of each search term in the search query to each search term of each other search query of the set of search queries.

3. The method of claim 2, wherein the generating of the cluster similarity score for the set of search queries further comprises:
aggregating, by the processing device, the search query similarity score of each search query of the set of search queries to generate the cluster similarity score.

4. The method of claim 3, wherein the method further comprises:
determining, by the processing device, a search query success outcome of a search query of the set of search queries based on the search query similarity score of the search query; and
classifying by the processing device, the search query success outcome as a successful search query based on the search query similarity score falling below a predefined threshold.

5. The method of claim 1 wherein the determining of the success outcome further comprises:
classifying by the processing device, the success outcome as successful based on the cluster similarity score falling below a predefined threshold.

6. The method of claim 1, wherein the similarity index comprises determining an entropy for the set of search queries.

7. The method of claim 6, wherein the determining of the entropy comprises computing:
$$entropy = {\sum }_{i = 1}^{n} {w}_{i} {log}_{2} ( {w}_{i} ) = {w}_{1} {log}_{2} ( {w}_{1} ) + {w}_{2} {log}_{2} ( {w}_{2} ) + … + {w}_{n} {log}_{n} ( {w}_{n} ) ,$$
wherein w₁ represents a first number of occurrences of a first unique search term in the set of search queries, and wherein w₂ represents a second number of occurrences of a second unique search term in the set of search queries, and wherein wₙ represents another number of occurrences of another unique search term in the set of search queries, and wherein w₁ represents at least one of w₁, w₂, or wₙ.

8. The method of claim 1, wherein the similarity index comprises determining a similarity metric value for the set of search queries.

9. The method of claim 8, wherein the determining of the similarity metric value comprises determining a ratio of total search terms over total unique search terms in the set of search queries.

10. The method of claim 1, further comprising:
commencing, by the processing device, a duration to perform one or more search queries; and
ending the duration, wherein the set of search queries comprises the one or more search queries.

11. The method of claim 1, further comprising:
receiving one or more user inputs comprising at least one of a user input to set a starting point of a duration or a user input to set an ending point of the duration, wherein the set of search queries comprises one or more search queries performed during the duration.

12. The method of claim 1, further comprising:
receiving an indication configuring a size for the set of search queries, wherein the indication may set a minimum number or a maximum number of search queries for the set of search queries.

13. The method of claim 1, further comprising:
initiating a search query session; and
ending the search query session, wherein the set of search queries is performed within the search query session.

14. The method of claim 13, further comprising:
detecting a pause of search queries during the search query session, wherein a pause duration of the pause meets a pause duration limit, and wherein the ending of the search query session is associated with the pause duration meeting the pause duration limit.

15. The method of claim 1, wherein the receiving of the set of search queries comprises receiving one or more search queries during a search query session.

16. The method of claim 1, wherein the determining of the success outcome comprises:
classifying at least one of a search query of the set of search queries or the set of search queries as successful or unsuccessful based on at least one of the cluster similarity score or a search query similarity score.

17. The method of claim 1, further comprising:
adding, by the processing device, to a data repository, at least one of the set of search queries or a search query of the set of search queries based on the cluster similarity score, the success outcome, or a search query success outcome.

18. The method of claim 17, further comprising:
retrieving, by the processing device, from the data repository, at least one of the set of search queries or the search query based on an active search query or an active set of search queries; and
providing a search query recommendation based on the active search query or the active set of search queries, and at least one of the set of search queries or the search query.

19. The method of claim 17, further comprising:
replacing an active search query with a successful search query of the set of search queries based on a similarity score of the active set of search queries or a similarity score of the active search query.

20. A search platform system for advanced search queries, comprising a processing system that includes one or more processors and one or more memories coupled with the one or more processors, the processing system configured to cause the system to:
receive, by a processing device, a set of search queries;
generate, by the processing device, user inputs comprising a cluster similarity score for the set of search queries based on a similarity index, wherein the similarity index is configured to consider each search term of one or more search queries of the set of search queries;
determine, by the processing device, based on the cluster similarity score, a success outcome of the set of search queries, wherein the determination of the success outcome is independent of user interactions;
retrieve search data from a database, wherein the search data is based on the cluster similarity score, the success outcome, or other scores or metrics associated with the set of search queries; and
automatically replace at least one search term of at least one search query of the one or more search queries based on the search data to generate at least one improved search result.

21. One or more non-transitory computer-readable media comprising executable instructions that, when executed by one or more processors, perform operations comprising:
receiving, by a processing device, user inputs comprising a set of search queries;
generating, by the processing device, a cluster similarity score for the set of search queries based on a similarity index, wherein the similarity index is configured to consider each search term of one or more search queries of the set of search queries;
determining, by the processing device, based on the cluster similarity score, a success outcome of the set of search queries, wherein the determining of the success outcome is independent of user interactions;
retrieving search data from a database, wherein the search data is based on the cluster similarity score, the success outcome, or other scores or metrics associated with the set of search queries; and
automatically replacing at least one search term of at least one search query of the one or more search queries based on the search data to generate at least one improved search result.
